(19) United States
(12) Patent Application Publication
(10) Pub. No.: US 2024/0029073 A1
(43) Pub. Date: Jan. 25, 2024

(54) METHOD AND SYSTEM OF FACILITATING PAYMENTS THROUGH AN INTERMEDIARY PLATFORM

(71) Applicant: Mastercard International Incorporated, Purchase, NV (US)

(72) Inventors: Samrat RAJ, Scarsdale, NY (US); William SILBER, Holbrook, NY (US); Rohit CHHAJED, Stamford, CT (US); Molly BASKIN, Stamford, CT (US)

(21) Appl. No.: 17/870,199

(22) Filed: Jul. 21, 2022

(51) Int. Cl. G06Q 20/40; G06Q 20/42

(52) U.S. Cl. CPC G06Q 20/405; G06Q 20/42; G06Q 20/4014

(57) ABSTRACT

A method for facilitating payments across multiple platforms and networks includes: establishing communication channels with each of a plurality of enterprise systems; establishing communication channels with each of a plurality of payment networks; receiving a payment request message via one of the enterprise systems using the associated channel, the payment request message including a payee identifier and payment amount; identifying a computing device based on the payee identifier; transmitting a notification message to the computing device including the payment amount; receiving a response message from the computing device including a network identifier; and processing payment of the payment amount to a payee using one of the payment networks selected based on the network identifier, wherein processing payment of the payment amount includes transmitting one or more data messages to the one of the payment networks using the established communication channel.

### FIELD

The present disclosure relates to facilitating payments through an intermediary platform, specifically the facilitation of payments originating from multiple enterprise systems to payees utilizing a plurality of different payment methods.

### BACKGROUND

Many merchants, companies, and other such vendors utilize enterprise systems to streamline management of many day-to-day business needs. One popular usage of enterprise systems is to manage payments made by vendors. An enterprise system enables a vendor to organize and manage all of their payments to payees in one place, providing convenience to the vendor. However, to receive payment, the payees must use the vendor's enterprise system. If a payee expects payments from multiple vendors, each of whom use different enterprise system, the payee must register with and use each of the enterprise systems. This can be laborious for many payees as the enterprise systems often use different formats.

Additionally, the methods of payment provided by enterprise systems can greatly vary, which may require a payee to be paid via several different methods. This can be overly complicated for many payees, may result in business difficulties, and can be a security risk by having account information for multiple accounts stored across a variety of different systems. Furthermore, some payees may refrain from transacting with some vendors depending on the enterprise system the vendor uses because of these problems, which can negatively affect the vendor's business.

Thus, there is a need for a technical improvement to existing methods and systems for payments made using enterprise systems.

### SUMMARY

The present disclosure provides a description of systems and methods for facilitating payments across multiple platforms and networks. A central processing system, also referred to herein as a processing server, is connected to a plurality of different enterprise systems, each of which can utilize different formatting rules and communication protocols. A vendor initiates a payment using their enterprise system, which forwards a payment request message to the central processing system. The central processing system identifies the payee using the payment request message and contacts the payee, such as via an e-mail or short message service message. The payee selects a preferred payment method and provides the appropriate details to the central processing system. The central processing system, which is in communication with a plurality of different payment networks to provide for the varied payment methods, initiates the payment to the payee using their preferred payment method via the associated payment network. As a result, vendors can continue to use their existing enterprise systems without any changes to their operations, while payees can get paid using any preferred method regardless of the enterprise system used by the vendor, providing for significantly more convenience, security, and scalability of the present systems and methods over traditional systems and methods.

A method for facilitating payments across multiple platforms and networks includes: establishing, by a processing server, communication channels with each of a plurality of enterprise systems using one or more communication protocols; establishing, by the processing server, communication channels with each of a plurality of payment networks; receiving, by a receiver of the processing server, a payment request message via one of the plurality of enterprise systems using the associated established communication channel, the payment request message including at least a payee identifier and a payment amount; identifying, by a processor of the processing server, a computing device based on at least the payee identifier; transmitting, by a transmitter of the processing server, a notification message to the identified computing device including at least the payment amount; receiving, by the receiver of the processing server, a response message from the identified computing device, the response message including at least a network identifier; and processing, by the processor of the processing server, payment of the payment amount to a payee using one of the plurality of payment networks, wherein the one of the plurality of payment networks is selected based on the network identifier, and wherein processing payment of the payment amount includes transmitting one or more data messages to the one of the plurality of payment networks using the associated established communication channel.

A system for facilitating payments across multiple platforms and networks includes: a plurality of enterprise systems; a plurality of payment networks; a computing device; and a processing server, wherein the processing server establishes communication channels with each of the plurality of enterprise systems using one or more communication protocols; establishes communication channels with each of the plurality of payment networks; receives, by a receiver of the processing server, a payment request message via one of the plurality of enterprise systems using the associated established communication channel, the payment request message including at least a payee identifier and a payment amount; identifies, by a processor of the processing server, the computing device based on at least the payee identifier; transmits, by a transmitter of the processing server, a notification message to the identified computing device including at least the payment amount; receives, by the receiver of the processing server, a response message from the identified computing device, the response message including at least a network identifier; and processes, by the processor of the processing server, payment of the payment amount to a payee using one of the plurality of payment networks, wherein the one of the plurality of payment networks is selected based on the network identifier, and wherein processing payment of the payment amount includes transmitting one or more data messages to the one of the plurality of payment networks using the associated established communication channel.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for facilitating payments across multiple platforms and networks in accordance with exemplary embodiments.

FIG. 2 is a block diagram illustrating the processing server in the system of FIG. 1 for facilitating payments across multiple platforms and networks in accordance with exemplary embodiments.

FIG. 3 is a flow diagram illustrating a process for facilitating payments across multiple platforms and networks in the system of FIG. 1 in accordance with exemplary embodiments.

FIG. 4 is a flow chart illustrating an exemplary method for facilitating payments across multiple platforms and networks in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### System for Facilitating Payments Across Multiple Platforms

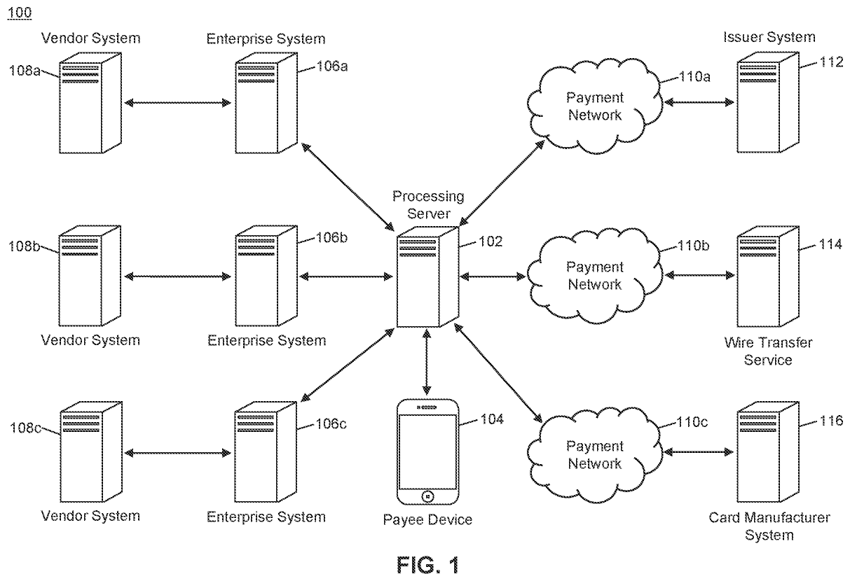

FIG. 1 illustrates a system 100 for facilitating payments across multiple enterprise platforms using a variety of payment methods through a centralized processor.

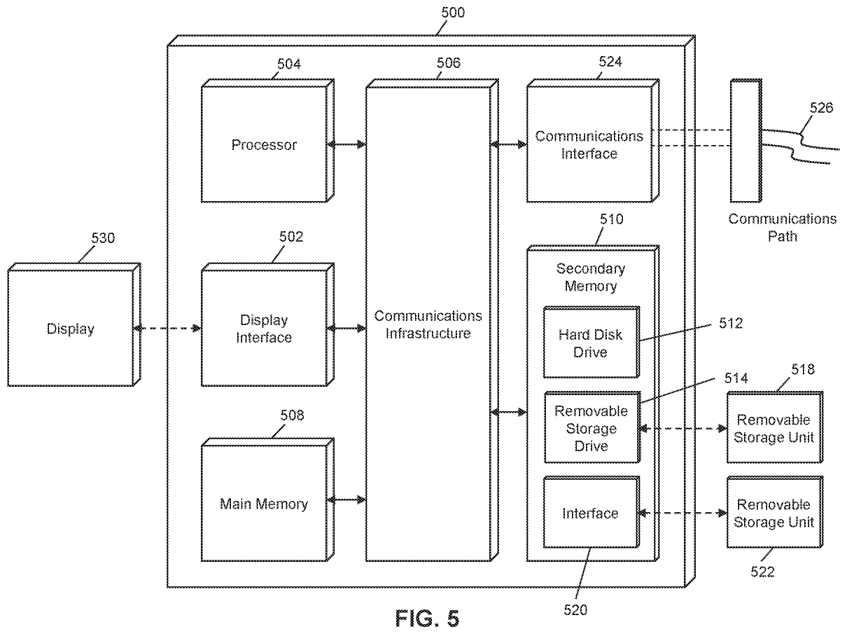

The system 100 can include a processing server 102. The processing server 102, discussed in more detail below, can be a central processing system configured to facilitate payments made between vendors and payees through a plurality of different enterprise platforms and using a plurality of different payment methods. The system 100 can also include a payee device 104, which can be a computing device, such as illustrated in FIG. 5 and discussed in more detail below, through which a payee interacts with the processing server 102. As discussed herein, payee device 104 can refer to the computing device used by the payee, which can include a desktop computer, laptop computer, notebook computer, tablet computer, cellular phone, smart phone, smart watch, smart television, wearable computing device, implantable computing device, etc. or refer to the payee and/or actions performed by the payee. The payee device 104 can interact with the processing server 102 using any suitable communication networks and methods, such as via e-mail, short messaging service messages, application programs, web pages, etc.

In the system 100, a payee device 104 can expect to receive a payment from one or more vendor systems 108, illustrated in FIG. 1 as vendor systems 108a, 108b, and 108c. Each vendor system can be a system of one or more computing devices, such as illustrated in FIG. 5 and discussed in more detail below, associated with a vendor that can make payments to the payee and, in some cases, can refer to the vendor itself as an entity, as applicable. The payee device 104 can agree with the vendor system 108 regarding a payment to be made to the payee by the vendor, such as to procure goods or services from the payee.

The vendor system 108 can be interfaced or otherwise in communication with an enterprise system 106, illustrated in FIG. 1 as enterprise systems 106a, 106b, and 106c. An enterprise system 106 can be a system of one or more computing devices, such as illustrated in FIG. 5 and discussed in more detail below, that provides for enterprise resource planning for the vendor system 108, such as to assist in the management of day-to-day business activities for the vendor, including, for example, accounting, procurement, project management, risk management, compliance, supply chain operations, etc. In the system 100, the enterprise systems 106 can provide accounting services for the vendor systems 108 including the ability for payments to be made or received on behalf of the vendor system 108.

When the vendor system 108 needs to make a payment to the payee device 104, the vendor system 108 can provide payment information to their enterprise system 106. In traditional methods, the vendor system 108 can provide the payment amount to the enterprise system 106, which facilitates payment of the payment amount to the payee. In some cases, the payee device 104 can provide account information for a transaction account with which the payee is interested in receiving payment to the vendor system 108 to provide to the enterprise system 106. In other cases, the enterprise system 106 can communicate with the payee device 104 and receive the account information directly therefrom. In either instance, the payee device 104 is limited to the payment methods accepted by the enterprise system 106 and must surrender their account information to every enterprise system 106 in the system 100 through which they wish to receive payment.

In the system 100, the vendor system 108 can provide the payment amount and contact information for the payee device 104 to their enterprise system 106. The enterprise system 106 can have an established communication channel with the processing server 102 using a suitable protocol through which the enterprise system 106 can electronically transmit a payment request message to the processing server 102. The payment request message is a data message that includes at least the payment amount and the contact information for the payee device 104. The contact information can include any information used for the processing server 102 to identify and establish communication with the payee device 104, such as a telephone number, e-mail address, username, internet protocol address, etc. In some cases, the payment request message can include additional data, such as an invoice number, transaction identifier, vendor name, etc., which can be included in one or more subsequent data messages discussed herein.

The processing server 102 can receive the payment request message and can identify the contact information for the payee as included therein. The processing server 102 can then electronically transmit a notification message to the payee device 104 using a suitable communication network and method that includes at least the payment amount, and can further include any of the additional data from the payment request message as discussed above, such as vendor name and invoice number. The notification message can further include a list of potential payment methods that can be utilized by the processing server 102 to enable receipt of payment by the payee device 104.

For example, in an exemplary embodiment, the processing server 102 can have communication channels established with a plurality of different payment networks 110, illustrated in FIG. 1 as payment networks 110a, 110b, and 110c. Each payment network 110 can be a different physical network that utilizes a different protocol and/or formatting rules for messages electronically transmitted to and/or from the payment network 110. In some cases, each payment network 110 can be in communication with a different entity associated with a different payment method that can be utilized by the payee device 104. In some instances, the payment networks 110 can include two or more payment networks that utilize the same payment method, but can utilize different physical networks and/or protocols. For instance, a payment network 110a can be a credit card processing network for processing payments using a first type of credit card, while a payment network 110b can be a different credit cart processing network for processing payments using a second type of credit card.

The notification message transmitted to the payee device 104 by the processing server 102 can present the payee with a choices of payment methods corresponding to the payment networks 110 with which the processing server 102 has established communication channels. The payee device 104 can present the notification message to the payee, who can select a desired payment method and provide any information necessary for payment through the desired payment method, as discussed below. The payee device 104 can electronically transmit a response message to the processing server 102 using the established communication network and method, where the response message includes the selected payment method and any additional necessary information. The processing server 102 can then transmit the relevant information to the payment network 110 associated with the selected payment method, which can then process payment to the payee accordingly.

In some instances, a vendor system 108 can place one or more limits on the potential payment methods that can be selected by a payee. For instance, a vendor system 108 can place monetary limits on payment methods (e.g., wire transfer or direct deposit for any payment below $10,000, but only wire transfer on payments above $10,000), place restrictions on the use of a payment method available to the processing server 102, etc. In such instances, the notification message electronically transmitted by the processing server 102 can only list the payment methods that satisfy the criteria set forth by the vendor system 108 for selection by the payee device 104.

In the example illustrated in FIG. 1, the payment network 110a is in communication with an issuer system 112, which can be a computing system of one or more computing devices, such as illustrated in FIG. 5 and discussed in more detail below, that is associated with an issuing financial institution that issues a transaction account to the payee for use in receiving payments. The payee can select a direct deposit into their transaction account for payment. In such an instance, the payee can provide the account information (e.g., account number, routing number, etc.) for the transaction account to the processing server 102 in the response message. The processing server 102 can provide the account information and payment amount to the payment network 110a, which can facilitate a deposit into the payee's transaction account at the issuer system 112 for the transaction amount (e.g., from a transaction account associated with the vendor, information for which the payment network 110a can already have, be provided by the payee device 104 in the response message, or be provided to the processing server 102 by the enterprise system 106 in the payment request message and forwarded on by the processing server 102 to the payment network 110a).

In the illustrated example, the processing server 102 can be in communication with a payment network 110b, which can be in communication with a wire transfer service 114. The wire transfer service can be configured to facilitate wire transfers between transaction accounts. In such instances, the payee device 104 can provide suitable account information for an account configured to receive wire transfers to the processing server 102, which can forward the information as well as any other relevant information (e.g., originating account information from an enterprise system 106) to the payment network 110b for routing to the wire transfer service 114. The wire transfer service 114 can then effect a wire transfer for the payment amount to the payee's selected account.

Also in the illustrated example, the processing server 102 can have an established communication channel with a payment network 110c, which is in communication with a card manufacturer system 116. The card manufacturer system 116 can be configured to manufacture credit cards, debit cards, or other types of payment cards. The payee device 104 can select payment via a prepaid card when selecting the desired payment method, which can be provided to the processing server 102 in the notification message, as well as a mailing address for receipt of the prepaid card. The processing server 102 can provide the payment amount and mailing address to the payment network 110c for forwarding to the card manufacturer system 116. The card manufacturer service 116 can then issue a prepaid card for the payment amount to the payee, which can be mailed to the payee at the provided mailing address.

The system 100 can also facilitate payments using additional payment methods not illustrated in FIG. 1. For example, payment can also be made using a controlled payment number, a Real Time Payment, the automated clearinghouse, wire transfer, check, debit card, etc. In some embodiments, the processing server 102 can be further configured to provide additional functionality to the benefit of payee devices 104, enterprise systems 106, and vendor systems 108. For instance, the processing server 102 can assist with alias and threshold management, provide know your customer services, facilitate the distribution and redemption of offers, connect potential payees with eligible vendors that are part of the platform provided by the processing server 102, provide fraud monitoring, etc.

In the system 100, the processing server 102 can have communication with a plurality of different payment networks 110 as well as established communication channels with each of a plurality of different enterprise systems 106. Each of the enterprise systems 106 can utilize different communication networks or protocols, and can format data messages using a different format and/or standard. The processing server 102 can be configured to communicate with each enterprise system 106 using the appropriate communication network and protocol and can be configured to parse the necessary data from a data message from each enterprise system 106 regardless of format. The result is a system and method where a payee can interact with any number of vendor systems 108, each of which can utilize a different enterprise system 106, and receive payment using a variety of different payment methods, where each enterprise system 106 can utilize its existing systems, processes, and formats without the need to interact directly with any payment networks 110 and each vendor system 108 can continue business as usual processes with their enterprise systems, where the payee device 104 does not need to provide any sensitive financial information to any enterprise system 106 or vendor system 108. Thus, payees have significantly greater protection and security while also having significantly more variety and convenience in receiving payments, all without negatively affecting vendor systems 108 and enterprise systems 106.

### Processing Server

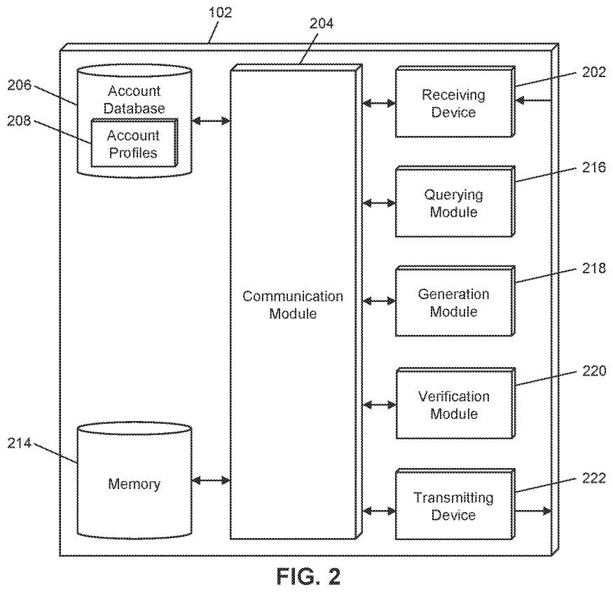

FIG. 2 illustrates an embodiment of a processing server 102. It will be apparent to persons having skill in the relevant art that the embodiment of the processing server 102 illustrated in FIG. 2 is provided as illustration only and cannot be exhaustive to all possible configurations of the processing server 102 suitable for performing the functions as discussed herein. For example, the computer system 500 illustrated in FIG. 5 and discussed in more detail below can be a suitable configuration of the processing server 102. In some cases, additional components of the system 100, such as the payee device 104, enterprise systems 106, vendor systems 108, payment networks 110, issuer systems 112, wire transfer services 114, and card manufacturer systems 116 can include the components illustrated in FIG. 2 and discussed below.

The processing server 102 can include a receiving device 202. The receiving device 202 can be configured to receive data over one or more networks via one or more network protocols. In some instances, the receiving device 202 can be configured to receive data from payee devices 104, enterprise systems 106, payment networks 110, and other systems and entities via one or more communication methods, such as radio frequency, local area networks, wireless area networks, cellular communication networks, Bluetooth, the Internet, etc. In some embodiments, the receiving device 202 can be comprised of multiple devices, such as different receiving devices for receiving data over different networks, such as a first receiving device for receiving data over a local area network and a second receiving device for receiving data via the Internet. The receiving device 202 can receive electronically transmitted data signals, where data can be superimposed or otherwise encoded on the data signal and decoded, parsed, read, or otherwise obtained via receipt of the data signal by the receiving device 202. In some instances, the receiving device 202 can include a parsing module for parsing the received data signal to obtain the data superimposed thereon. For example, the receiving device 202 can include a parser program configured to receive and transform the received data signal into usable input for the functions performed by the processing device to carry out the methods and systems described herein.

The receiving device 202 can be configured to receive data signals electronically transmitted by payee devices 104 that are superimposed or otherwise encoded with response messages, account information, selected payment methods, contact information, requests for vendor information, payment preferences, etc. The receiving device 202 can also be configured to receive data signals electronically transmitted by enterprise systems 106, which can be superimposed or otherwise encoded with payment request messages, onboarding information, account information, payment method limits and/or criteria, vendor information, etc. The receiving device 202 can also be configured to receive data signals electronically transmitted by payment networks 110 that can be superimposed or otherwise encoded with notification messages, requests for data, data formatting rules, payment notifications, etc.

The processing server 102 can also include a communication module 204. The communication module 204 can be configured to transmit data between modules, engines, databases, memories, and other components of the processing server 102 for use in performing the functions discussed herein. The communication module 204 can be comprised of one or more communication types and utilize various communication methods for communications within a computing device. For example, the communication module 204 can be comprised of a bus, contact pin connectors, wires, etc. In some embodiments, the communication module 204 can also be configured to communicate between internal components of the processing server 102 and external components of the processing server 102, such as externally connected databases, display devices, input devices, etc. The processing server 102 can also include a processing device. The processing device can be configured to perform the functions of the processing server 102 discussed herein as will be apparent to persons having skill in the relevant art. In some embodiments, the processing device can include and/or be comprised of a plurality of engines and/or modules specially configured to perform one or more functions of the processing device, such as a querying module 216, generation module 218, verification module 220, etc. As used herein, the term “module” can be software or hardware particularly programmed to receive an input, perform one or more processes using the input, and provides an output. The input, output, and processes performed by various modules will be apparent to one skilled in the art based upon the present disclosure.

The processing server 102 can also an account database 206. The account database 206 can be configured to store one or more account profiles 208 using a suitable data storage format and schema. The account database 206 can be a relational database that utilizes structured query language for the storage, identification, modifying, updating, accessing, etc. of structured data sets stored therein. Each account profile 208 can be a structured data set configured to store data related to a payee device 104, enterprise system 106, vendor system 108, or payment network 110. For instance, an account profile 208 related to a payee device 104 can be used to store payment preferences, account information, contact information, etc. In another example, an account profile 208 related to a vendor system 108 can be used to store payment method criteria, account information, enterprise system 106 information and rules, etc.

The processing server 102 can also include a memory 214. The memory 214 can be configured to store data for use by the processing server 102 in performing the functions discussed herein, such as public and private keys, symmetric keys, etc. The memory 214 can be configured to store data using suitable data formatting methods and schema and can be any suitable type of memory, such as read-only memory, random access memory, etc. The memory 214 can include, for example, encryption keys and algorithms, communication protocols and standards, data formatting standards and protocols, program code for modules and application programs of the processing device, and other data that can be suitable for use by the processing server 102 in the performance of the functions disclosed herein as will be apparent to persons having skill in the relevant art. In some embodiments, the memory 214 can be comprised of or can otherwise include a relational database that utilizes structured query language for the storage, identification, modifying, updating, accessing, etc. of structured data sets stored therein. The memory 214 can be configured to store, for example, cryptographic keys, cryptographic key pairs, cryptographic algorithms, encryption algorithms, communication information, data formatting rules, transaction request message formatting rules, network identifiers, etc.

The processing server 102 can include a querying module 216. The querying module 216 can be configured to execute queries on databases to identify information. The querying module 216 can receive one or more data values or query strings, and can execute a query string based thereon on an indicated database, such as the entity database 206 of the processing server 102 to identify information stored therein. The querying module 216 can then output the identified information to an appropriate engine or module of the processing server 102 as necessary. The querying module 216 can, for example, execute a query on the account database 206 to identify an account profile 208 associated with a vendor system 108 for which a payment request message has been received, such as to identify criteria for payment method selection for use when generating a notification message.

The processing server 102 can also include a generation module 218. The generation module 218 can be configured to generate data for use by the processing server 102 in performing the functions discussed herein. The generation module 218 can receive instructions as input, can generate data based on the instructions, and can output the generated data to one or more modules of the processing server 102. For example, the generation module 218 can be configured to generate data messages, notification messages, transaction messages, payment method selection lists, transaction identifiers, session identifiers, cryptographic keys, etc.

The processing server 102 can also include a verification module 220. The verification module 220 can be configured to perform verifications for the processing server 102 as part of the functions discussed herein. The verification module 220 can receive instructions as input, which can also include data to be used in performing a verification, can perform a verification as requested, and can output a result of the verification to another module or engine of the processing server 102. The verification module 220 can, for example, be configured to verify account information, payment method selections, payment amounts, notifications of processed payments, generated data messages, etc.

The processing server 102 can also include a transmitting device 222. The transmitting device 222 can be configured to transmit data over one or more networks via one or more network protocols. In some instances, the transmitting device 222 can be configured to transmit data to payee devices 104, enterprise systems 106, payment networks 110, and other entities via one or more communication methods, local area networks, wireless area networks, cellular communication, Bluetooth, radio frequency, the Internet, etc. In some embodiments, the transmitting device 222 can be comprised of multiple devices, such as different transmitting devices for transmitting data over different networks, such as a first transmitting device for transmitting data over a local area network and a second transmitting device for transmitting data via the Internet. The transmitting device 222 can electronically transmit data signals that have data superimposed that can be parsed by a receiving computing device. In some instances, the transmitting device 222 can include one or more modules for superimposing, encoding, or otherwise formatting data into data signals suitable for transmission.

The transmitting device 222 can be configured to electronically transmit data signals to payee devices 104 that can be superimposed or otherwise encoded with notification messages, vendor information messages, requests for account information, contact information requests, completed payment information, etc. The transmitting device 222 can also be configured to electronically transmit data signals to enterprise systems 106, which can be superimposed or otherwise encoded with account information requests, payment notifications, responses to payment request messages, contact information requests, etc. The transmitting device 222 can also be configured to electronically transmit data signals to payment networks 110 that can be superimposed or otherwise encoded with transaction messages, payment requests, account information, payment amounts, etc.

### Process for Facilitating Payments

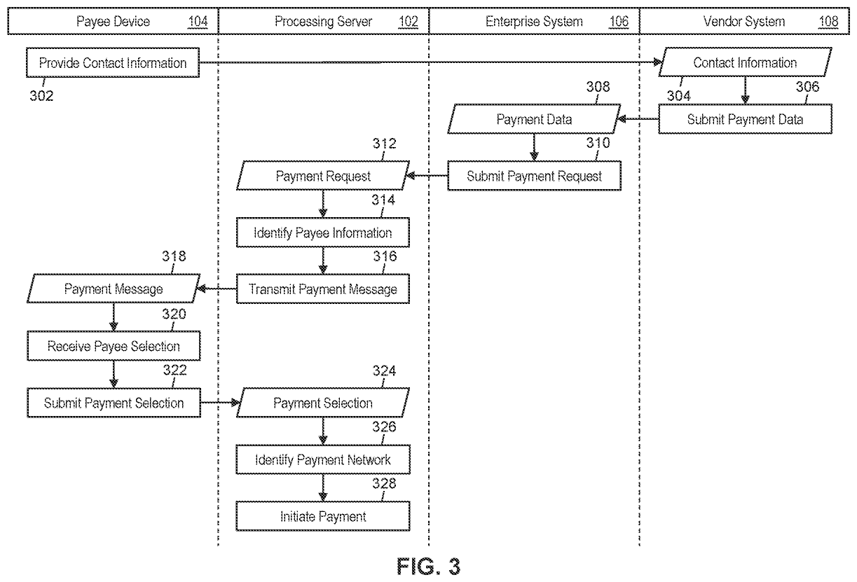

FIG. 3 illustrates a process 300 for facilitating payments using one of a plurality of payment methods originating from one of a plurality of different enterprise systems 106 in the system 100 of FIG. 1.

In step 302, the payee device 104 can provide contact information for the payee device 104 to the vendor system 108. The contact information can include, for example, an e-mail address, telephone number, username, etc. In step 304, the vendor system 108 can receive the contact information from the payee device 104 using a suitable communication network and method. In step 306, the vendor system 108 can submit payment data for a new payment to be made to their enterprise system 106 using a suitable communication network and method, such as using an application programming interface or application program provided by the enterprise system 106. The payment data can include at least a payment amount and the contact information for the payee device 104, and can further include any other necessary data, such as account information for a transaction account of the vendor to be used to supply funds for the requested payment. In step 308, the enterprise system 106 can receive the payment data from the vendor system 108.

In step 310, the enterprise system 106 can submit a payment request message to the processing server 102 using a suitable communication network and method, where the payment request message can be formatted using a standard format provided by the processing server 102 or can be formatted according to a format set forth by the enterprise system 106. The payment request message can include the payment amount, contact information, and any other necessary information received from the vendor system 108 or supplied by the enterprise system 106, such as account information for the vendor. In step 312, the receiving device 202 of the processing server 102 can receive the payment request message.

In step 314, the querying module 216 or other suitable engine of the processing server 102 can identify the contact information in the payment request message. The generation module 218 of the processing server 102 can generate a payment message, also referred to herein as a notification message, which can include at least the payment amount as well as a list of possible payment methods, where the list of possible payment methods can be generated based on the payment networks 110 in communication with the processing server 102 and/or criteria set forth by the vendor system 108 and/or enterprise system 106, such as can be identified in an account profile 208 stored in the account database 206 of the processing server 102 associated therewith. In step 316, the transmitting device 222 of the processing server 102 can electronically transmit the payment message to the payee device 104 using the contact information. For instance, if the contact information is an e-mail address, the payment message can be an e-mail that is transmitted to the e-mail address, which can be received and displayed on the payee device 104.

In step 318, the payee device 104 can receive the payment message from the processing server 102. In some cases, the payee device 104 can receive a uniform resource locator or other value or data file that can direct the payee device 104 to the payment message. For example, the payee device 104 can receive an e-mail that includes the payment amount and vendor name as well as a link to web page that includes more detailed information regarding the payment as well as the list of selectable payment methods and fields for entering additional information, as applicable. In step 320, the payee device 104 can display the list of selectable payment methods to the user thereof (e.g., the payee) and receive a selection therefrom using a suitable input method as well as any other additional information as necessary based on the selected payment method. In step 322, the payee device 104 can submit (e.g., via a response e-mail, a web page form submission, etc.) the selected payment method and any necessary additional data to the processing server 102 using a suitable communication network and method.

In step 324, the receiving device 202 of the processing server 102 can receive the payment selection from the payee device 104. In step 326, the processing server 102 can identify a payment network 110 to use based on the payment method selected by the payee device 104. For instance, in the system 100 of FIG. 1, if the payee device 104 selects a prepaid card, the processing server 102 can identify the payment network 110c for payment, whereas, if the payee device 104 selects a direct deposit, the processing server 102 can identify the payment network 110a for payment. In step 328, the transmitting device 222 can electronically transmit a data message to the identified payment network 110 that includes the payment amount and any additional necessary information, as applicable, to facilitate payment of the payment amount to the payee using the selected method. For instance, in the above examples, the payee can be provided a prepaid card that is loaded with the payment amount, or can receive a direct deposit of the payment amount into their desired transaction account.

### Exemplary Method for Facilitating Payments Across Multiple Platforms

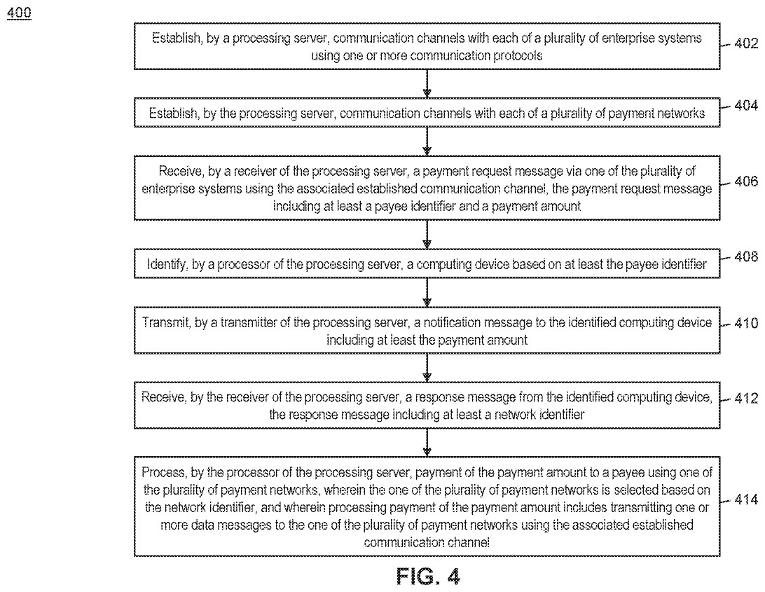

FIG. 4 illustrates a method 400 for facilitating payments across a plurality of different enterprise systems and payment networks.

In step 402, communication channels can be established by a processing server (e.g., processing server 102) with each of a plurality of enterprise systems (e.g., enterprise systems 106) using one or more communication protocols. In step 404, communication channels can be established by the processing server with each of a plurality of payment networks (e.g., payment networks 110). In step 406, a payment request message can be received by a receiver (e.g., receiving device 202) of the processing server via one of the plurality of enterprise systems using the associated established communication channel, the payment request message including at least a payee identifier and a payment amount. In step 408, a computing device (e.g., payee device 104) can be identified by a processor (e.g., querying module 216) of the processing server based on at least the payee identifier.

In step 410, a notification message can be transmitted by a transmitter (e.g., transmitting device 222) of the processing server to the identified computing device including at least the payment amount. In step 412, a response message can be received by the receiver of the processing server from the identified computing device, the response message including at least a network identifier. In step 414, payment of the payment amount can be processed by the processing server to a payee using one of the plurality of payment networks, wherein the one of the plurality of payment networks is selected based on the network identifier, and wherein processing payment of the payment amount includes transmitting one or more data messages to the one of the plurality of payment networks using the associated established communication channel.

In one embodiment, the plurality of payment networks can include at least one of: a credit card processing network, a debit card processing network, an automated clearing house, a wire transfer processing network, and a payment card processing system. In some embodiments, the payment request message can further include an invoice identifier, and the notification message can further include the invoice identifier. In one embodiment, the response message can further include payment details, and the payment can be processed to a transaction account associated with the payment details. In some embodiments, the method 400 can further include transmitting, by the transmitter of the processing server, a confirmation message to the one of the plurality of enterprise systems using the associated established communication channel indicating successful payment of the payment amount.

In one embodiment, the response message can further includes payment details, the one or more data messages can further include the payment details, and the method can also include: generating, by the one of the plurality of payment networks, a controlled payment number; and storing, in a database of the one of the plurality of payment networks, an association between the generated controlled payment number and the payment details. In some embodiments, the one or more data messages can be formatted based on one or more requirements associated with the one of the plurality of payment networks. In one embodiment, the payment request message can be formatted based on one or more requirements associated with the one of the plurality of enterprise systems.

### Computer System Architecture

FIG. 5 illustrates a computer system 500 in which embodiments of the present disclosure, or portions thereof, can be implemented as computer-readable code. For example, the processing server 102, payee device 104, enterprise systems 106, vendor systems 108, payment networks 110, issuer system 112, wire transfer service 114, and card manufacturer system 116 can be implemented in the computer system 500 using hardware, non-transitory computer readable media having instructions stored thereon, or a combination thereof and can be implemented in one or more computer systems or other processing systems. Hardware can embody modules and components used to implement the methods of FIGS. 3 and 4.

If programmable logic is used, such logic can execute on a commercially available processing platform configured by executable software code to become a specific purpose computer or a special purpose device (e.g., programmable logic array, application-specific integrated circuit, etc.). A person having ordinary skill in the art can appreciate that embodiments of the disclosed subject matter can be practiced with various computer system configurations, including multi-core multiprocessor systems, minicomputers, mainframe computers, computers linked or clustered with distributed functions, as well as pervasive or miniature computers that can be embedded into virtually any device. For instance, at least one processor device and a memory can be used to implement the above described embodiments.

A processor unit or device as discussed herein can be a single processor, a plurality of processors, or combinations thereof. Processor devices can have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations can be described as a sequential process, some of the operations can in fact be performed in parallel, concurrently, and/or in a distributed environment, and with program code stored locally or remotely for access by single or multi-processor machines. In addition, in some embodiments the order of operations can be rearranged without departing from the spirit of the disclosed subject matter.

Processor device 504 can be a special purpose or a general purpose processor device specifically configured to perform the functions discussed herein. The processor device 504 can be connected to a communications infrastructure 506, such as a bus, message queue, network, multi-core message-passing scheme, etc. The network can be any network suitable for performing the functions as disclosed herein and can include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 can also include a main memory 508 (e.g., random access memory, read-only memory, etc.), and can also include a secondary memory 510. The secondary memory 510 can include the hard disk drive 512 and a removable storage drive 514, such as a floppy disk drive, a magnetic tape drive, an optical disk drive, a flash memory, etc.

The removable storage drive 514 can read from and/or write to the removable storage unit 518 in a well-known manner. The removable storage unit 518 can include a removable storage media that can be read by and written to by the removable storage drive 514. For example, if the removable storage drive 514 is a floppy disk drive or universal serial bus port, the removable storage unit 518 can be a floppy disk or portable flash drive, respectively. In one embodiment, the removable storage unit 518 can be non-transitory computer readable recording media.

In some embodiments, the secondary memory 510 can include alternative means for allowing computer programs or other instructions to be loaded into the computer system 500, for example, the removable storage unit 522 and an interface 520. Examples of such means can include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) can be stored on any type of suitable computer readable media, such as optical storage (e.g., a compact disc, digital versatile disc, Blu-ray disc, etc.) or magnetic tape storage (e.g., a hard disk drive). The data can be configured in any type of suitable database configuration, such as a relational database, a structured query language (SQL) database, a distributed database, an object database, etc. Suitable configurations and storage types will be apparent to persons having skill in the relevant art.

The computer system 500 can also include a communications interface 524. The communications interface 524 can be configured to allow software and data to be transferred between the computer system 500 and external devices. Exemplary communications interfaces 524 can include a modem, a network interface (e.g., an Ethernet card), a communications port, a PCMCIA slot and card, etc. Software and data transferred via the communications interface 524 can be in the form of signals, which can be electronic, electromagnetic, optical, or other signals as will be apparent to persons having skill in the relevant art. The signals can travel via a communications path 526, which can be configured to carry the signals and can be implemented using wire, cable, fiber optics, a phone line, a cellular phone link, a radio frequency link, etc.

The computer system 500 can further include a display interface 502. The display interface 502 can be configured to allow data to be transferred between the computer system 500 and external display 530. Exemplary display interfaces 502 can include high-definition multimedia interface (HDMI), digital visual interface (DVI), video graphics array (VGA), etc. The display 530 can be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium can refer to memories, such as the main memory 508 and secondary memory 510, which can be memory semiconductors (e.g., DRAMs, etc.). These computer program products can be means for providing software to the computer system 500. Computer programs (e.g., computer control logic) can be stored in the main memory 508 and/or the secondary memory 510. Computer programs can also be received via the communications interface 524. Such computer programs, when executed, can enable computer system 500 to implement the present methods as discussed herein. In particular, the computer programs, when executed, can enable processor device 504 to implement the methods illustrated by FIGS. 3 and 4, as discussed herein. Accordingly, such computer programs can represent controllers of the computer system 500. Where the present disclosure is implemented using software, the software can be stored in a computer program product and loaded into the computer system 500 using the removable storage drive 514, interface 520, and hard disk drive 512, or communications interface 524.

The processor device 504 can comprise one or more modules or engines configured to perform the functions of the computer system 500. Each of the modules or engines can be implemented using hardware and, in some instances, can also utilize software, such as corresponding to program code and/or programs stored in the main memory 508 or secondary memory 510. In such instances, program code can be compiled by the processor device 504 (e.g., by a compiling module or engine) prior to execution by the hardware of the computer system 500. For example, the program code can be source code written in a programming language that is translated into a lower level language, such as assembly language or machine code, for execution by the processor device 504 and/or any additional hardware components of the computer system 500. The process of compiling can include the use of lexical analysis, preprocessing, parsing, semantic analysis, syntax-directed translation, code generation, code optimization, and any other techniques that can be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for facilitating payments across multiple platforms and networks. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or can be acquired from practicing of the disclosure, without departing from the breadth or scope.

What is claimed is:

1. A method for facilitating payments across multiple platforms and networks, comprising:
establishing, by a processing server, communication channels with each of a plurality of enterprise systems using one or more communication protocols;
establishing, by the processing server, communication channels with each of a plurality of payment networks;
receiving, by a receiver of the processing server, a payment request message via one of the plurality of enterprise systems using the associated established communication channel, the payment request message including at least a payee identifier and a payment amount;
identifying, by a processor of the processing server, a computing device based on at least the payee identifier;
transmitting, by a transmitter of the processing server, a notification message to the identified computing device including at least the payment amount;
receiving, by the receiver of the processing server, a response message from the identified computing device, the response message including at least a network identifier; and
processing, by the processor of the processing server, payment of the payment amount to a payee using one of the plurality of payment networks, wherein the one of the plurality of payment networks is selected based on the network identifier, and wherein processing payment of the payment amount includes transmitting one or more data messages to the one of the plurality of payment networks using the associated established communication channel.

2. The method of claim 1, wherein the plurality of payment networks include at least one of: a credit card processing network, a debit card processing network, an automated clearing house, a wire transfer processing network, and a payment card processing system.

3. The method of claim 1, wherein
the payment request message further includes an invoice identifier, and
the notification message further includes the invoice identifier.

4. The method of claim 1, wherein
the response message further includes payment details, and
the payment is processed to a transaction account associated with the payment details.

5. The method of claim 1, further comprising:
transmitting, by the transmitter of the processing server, a confirmation message to the one of the plurality of enterprise systems using the associated established communication channel indicating successful payment of the payment amount.

6. The method of claim 1, wherein
the response message further includes payment details,
the one or more data messages further includes the payment details, and
the method further comprises:
generating, by the one of the plurality of payment networks, a controlled payment number; and
storing, in a database of the one of the plurality of payment networks, an association between the generated controlled payment number and the payment details.

7. The method of claim 1, wherein the one or more data messages are formatted based on one or more requirements associated with the one of the plurality of payment networks.

8. The method of claim 1, wherein the payment request message is formatted based on one or more requirements associated with the one of the plurality of enterprise systems.

9. A system for facilitating payments across multiple platforms and networks, comprising:
a plurality of enterprise systems;
a plurality of payment networks;
a computing device; and
a processing server, wherein the processing server
establishes communication channels with each of the plurality of enterprise systems using one or more communication protocols;
establishes communication channels with each of the plurality of payment networks;
receives, by a receiver of the processing server, a payment request message via one of the plurality of enterprise systems using the associated established communication channel, the payment request message including at least a payee identifier and a payment amount;
identifies, by a processor of the processing server, the computing device based on at least the payee identifier;
transmits, by a transmitter of the processing server, a notification message to the identified computing device including at least the payment amount;
receives, by the receiver of the processing server, a response message from the identified computing device, the response message including at least a network identifier; and
processes, by the processor of the processing server, payment of the payment amount to a payee using one of the plurality of payment networks, wherein the one of the plurality of payment networks is selected based on the network identifier, and wherein processing payment of the payment amount includes transmitting one or more data messages to the one of the plurality of payment networks using the associated established communication channel.

10. The system of claim 1, wherein the plurality of payment networks include at least one of: a credit card processing network, a debit card processing network, an automated clearing house, a wire transfer processing network, and a payment card processing system.

11. The system of claim 1, wherein
the payment request message further includes an invoice identifier, and
the notification message further includes the invoice identifier.

12. The system of claim 1, wherein
the response message further includes payment details, and
the payment is processed to a transaction account associated with the payment details.

13. The system of claim 1, wherein the transmitter of the processing server transmits a confirmation message to the one of the plurality of enterprise systems using the associated established communication channel indicating successful payment of the payment amount.

14. The system of claim 1, wherein
the response message further includes payment details,
the one or more data messages further includes the payment details,
the one of the plurality of payment networks generates a controlled payment number, and
the one of the plurality of payment networks stores, in a database, an association between the generated controlled payment number and the payment details.

15. The system of claim 1, wherein the one or more data messages are formatted based on one or more requirements associated with the one of the plurality of payment networks.

16. The system of claim 1, wherein the payment request message is formatted based on one or more requirements associated with the one of the plurality of enterprise systems.
